(19) United States
(12) Patent Application Publication
(10) Pub. No.: US 2010/0303081 A1
(43) Pub. Date: Dec. 2, 2010

(54) COMMUNICATION SYSTEM AND METHOD FOR FORWARDING A PACKET AMONG A PLURALITY OF EDGE ROUTERS

(75) Inventor: Masatake MIYABE, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/784,041

(22) Filed: May 20, 2010

(30) Foreign Application Priority Data
May 26, 2009 (JP) 2009-126575

(51) Int. Cl. H04L 12/56

(52) U.S. Cl. 370/400

(57) ABSTRACT

A communication system is configured to include a plurality of edge nodes each coupled to a user network, and a plurality of point-to-point links each coupling a pair of edge nodes. Any pair of edge nodes is coupled via a point-to-point link included in the plurality of point-to-point links. When transmitting a first packet from a first user network coupled to a first edge node, to a second user network coupled to a second edge node, the first edge node creates a second packet by adding an ingress node identifier identifying the first edge node to the first packet received from the first user network. The second packet is forwarded among the plurality of edge nodes via point-to-point links, based on the ingress node identifier in the second packet and forwarding control information held in the each of the plurality of edge nodes.

### CROSS-REFERENCE TO RELATED APPLICATION

This application is based upon and claims the benefit of priority of the prior Japanese Patent Application No. 2009-126575, filed on May 26, 2009, the entire contents of which are incorporated herein by reference.

### FIELD

The present invention relates to a communication system and method for forwarding a packet among a plurality of edge routers.

### BACKGROUND

Recently, technology called a Multiprotocol Label Switching (MPLS), in which a packet is transferred based on a label attached to the packet, has been put into practical use. Further, a Virtual Private LAN Service (VPLS) is proposed as one of techniques for constructing a virtual private network based on the MPLS network. According to the VPLS, a pseudowire (PW), which is a virtual communication path providing a point-to-point link between a pair of edge routers among a plurality of edge routers, is established in a mesh topology. A pseudowire may be established along a MPLS tunnel through which a core router included in a MPLS network forwards a MPLS packet (a packet being transferred in the MPLS network) by referring a tunnel label attached to the MPLS packet. The VPLS provides Ethernet LAN services among user networks, by coupling each of the plurality of edge routers to a user network.

Each of the plurality of edge routers holds a routing table that records a forwarding address corresponding to each MAC address by learning a forwarding address of a MAC frame based on a Media Access Control (MAC) address stored in the MAC frame. Each of the plurality of edge routers determines a pseudowire through which a Mac frame is to be transmitted by referring the database and a destination MAC address included in the MAC frame, and encapsulate it in the MPLS packet. Each of the plurality of edge routers prohibits a MAC frame received from a pseudowire, from being forwarded to another pseudowire so as to construct a loop-free topology in the VPLS, that is, so as to prevent a MAC frame from looping in the VPLS. The prohibition of a MAC frame from being forwarded between different pseudowires is called “a split horizon”. Further, a device having a filtering function has been developed. According to the filtering function, the device monitors the MAC address of the received packet, and discards the received packet when the received packet is determined to be a packet transmitted by the device, based on the MAC address of the received packet.

It is desirable for a provider providing VPLS communication services to continue the provision of communication services among user networks even if a fault has occurred in a communication network having VPLS functions. For such occasions, a fault recovering technique has been developed in which a spare pseudowire or a spare MPLS tunnel is set beforehand. The fault recovering technique allows a communication service to be continued when a fault has occurred in the MPLS network equipped with a VPLS, by switching a pseudowire or a MPLS tunnel that may be affected by the fault, to the spare pseudowire or the spare MPLS tunnel.

According to the above fault recovering technique, edge routers and core routers in the MPLS network need to exchange signaling messages among them even if there are no faults occurring in the MPLS network, so as to determine label paths of the spare pseudowires or MPLS tunnels. Further, each of the edge routers and core routers needs to assign labels for spare pseudowires or MPLS tunnels and to forward the assigned labels among them. Therefore, a forwarding table held by each of the edge routers and core routers may increase in size. As a result, each of the edge routers and core routers needs to have processing capacity greater than that in the case where spare pseudowires or MPLS tunnels are not set in the MPLS network. Thus, a cost for each of the edge routers and core routers may increase.

### SUMMARY

According to an aspect of an embodiment, there is provided a communication method for forwarding a packet among a plurality of edge nodes each coupled to a user network, where each pair of edge nodes included in the plurality of edge nodes is coupled via a point-to-point link. A first edge node receives a first packet destined for a second user network coupled to a second edge node, from a first user network coupled to the first edge node. The first edge node creates a second packet by adding an ingress node identifier identifying the first edge node to the first packet. Then, the second packet is forwarded among the plurality of edge nodes using point-to-point links coupling the each pair of edge nodes included in the plurality of edge nodes, based on the ingress node identifier contained in the second packet and forwarding control information held in the each of the plurality of edge nodes. The forwarding control information includes information indicating whether the second packet is to be forwarded or discarded in association with an ingress node identifier. The second edge node receives the second packet from one of point-to-point links coupled to the second edge node, and restores the second packet to the original first packet by deleting the ingress node identifier from the second packet, so as to transmit the restored first packet to the second user network.

The object and advantages of the invention will be realized and attained by means of the elements and combinations particularly pointed out in the claims.

It is to be understood that both the foregoing general description and following detailed description are exemplary and explanatory and are not restrictive of the invention, as claimed.

### BRIEF DESCRIPTION OF DRAWINGS

FIG. 1 is a schematic diagram illustrating an example of a communication system, according to an embodiment;

FIG. 2 is a diagram illustrating a configuration example of an edge router, according to an embodiment;

FIG. 3 is a diagram illustrating an example of a packet that is forwarded in a communication system, according to an embodiment;

FIG. 4 is a diagram illustrating an example of a filter table, according to an embodiment;

FIG. 5 is a diagram illustrating an example of a route selection message, according to an embodiment;

FIG. 6 is a diagram illustrating an example of an operational flowchart for setting an alternative communication route, according to an embodiment;

FIGS. 7A, 7B are diagrams illustrating an example of an operational flowchart for setting an alternative communication route, according to an embodiment;

FIG. 8 is a diagram illustrating an example of an alternative communication route when a fault occurrence has been detected on a point-to-point link, according to an embodiment;

FIGS. 9A, 9B, 9C are diagrams illustrating an example of a filter table held by an edge router positioned along an alternative communication route, according to an embodiment;

FIG. 10 is a diagram illustrating an example of an alternative communication route when a fault occurrence has been detected on a plurality of point-to-point links, according to an embodiment;

FIGS. 11A, 11B, 11C are diagrams each illustrating an example of a filter table held by an edge router positioned along an alternative communication route, according to an embodiment; and

FIGS. 12A, 12B, 12C are diagrams each illustrating an example of filter tables held by an edge router positioned along an alternative communication route, according to an embodiment

### DESCRIPTION OF EMBODIMENTS

According to an embodiment, there is provided a communication system that includes a plurality of edge routers and provides a local area network service for a user network coupled to each of the plurality of edge routers. Further, virtual communication paths, each of which performs a point-to-point connection between a pair of edge routers among the plurality of edge routers, are established in full mesh topology within the communication network. Hereinafter, a virtual communication path that performs a point-to-point connection is also expressed as “a point-to-point link”. An edge router, upon detecting a fault on a point-to-point link that is used under normal conditions and coupled to the edge router, notifies other edge routers of an identification number of the edge router that has detected the fault occurrence on the point-to-point link. The other edge routers that have received the identification number of the edge router that has detected the fault occurrence on the point-to-point link, select and set an alternative communication route by coupling point-to-point links selected from among a plurality of point-to-point paths that are beforehand set in the MPLS network, so as to transmit packets having the same identification number through the selected alternative communication route. Thus, the present communication system allows an alternative communication route to be dynamically set at the time when a fault has occurred, without setting beforehand a spare point-to-point link for the faulty point-to-point link.

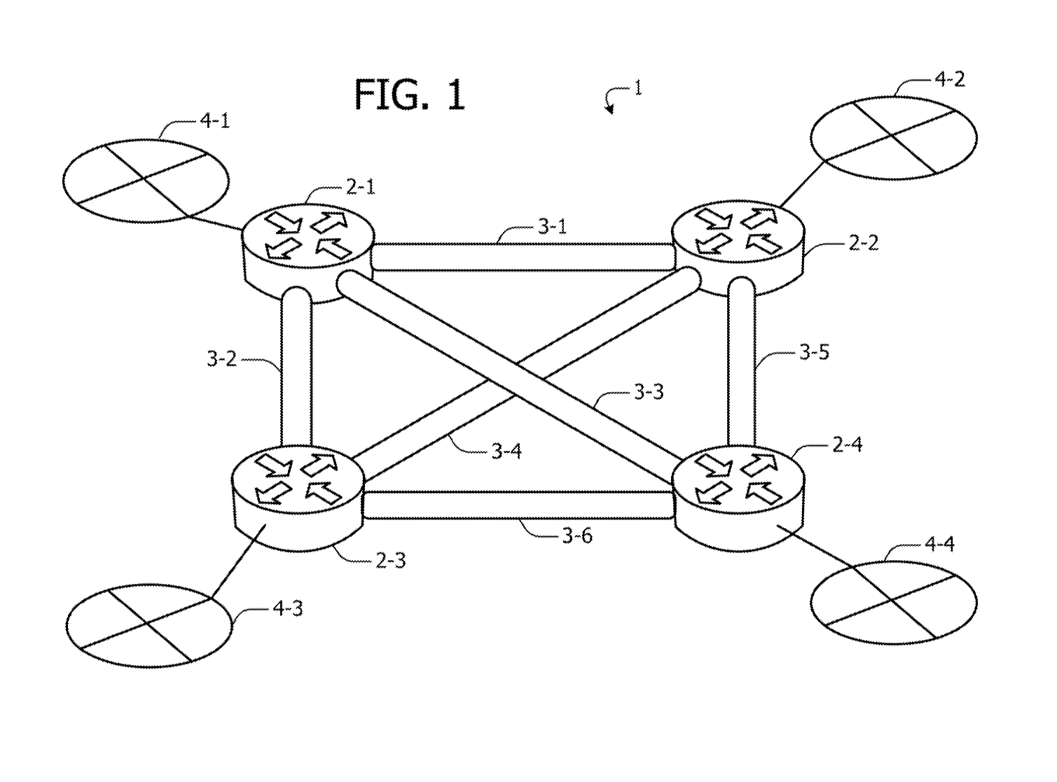

FIG. 1 is a schematic diagram illustrating an example of a communication system, according to an embodiment. In the example depicted in FIG. 1, a communication system 1 includes four edge routers 2-1, 2-2, 2-3, and 2-4. The communication system 1 implements, for example, a VPLS in a MPLS network that has been built on an Internet Protocol (IP) network. Therefore, pseudowires 3-1 to 3-6 are set, as point-to-point links, in a full-mesh topology among edge routers 2-1 to 2-4. For example, the pseudowire 3-1 is set as a point-to-point link between the edge routers 2-1 and 2-2, the pseudowire 3-2 is set as a point-to-point link between the edge routers 2-1 and 2-3, the pseudowire 3-3 is set as a point-to-point link between the edge routers 2-1 and 2-4, the pseudowire 3-4 is set as a point-to-point link between the edge routers 2-2 and 2-3, the pseudowire 3-5 is set as a point-to-point link between the edge router 2-2 and 2-4, and the pseudowire 3-6 is set as a point-to-point link between the edge routers 2-3 and 2-4.

Further, the edge routers 2-1 to 2-4 are coupled to user networks 4-1 to 4-4, respectively. An edge router included in the edge routers 2-1 to 2-4, upon receiving a MAC frame from the user network coupled to the edge router, creates a packet having a tunnel label for a MPLS tunnel and a pseudowire (PW) label for a pseudowire, corresponding to a destination address information contained in the received MAC frame. Then, the edge router forwards the created second packet to the pseudowire corresponding to the PW label. Further, an edge router included in the edge routers 2-1 to 2-4, upon receiving a packet from another edge router, extracts a MAC frame from the received packet, and forwards the extracted MAC frame to the user network coupled to the edge router.

A communication system 1 may be configured to include one or more core routers along with the edge routers 2-1 to 2-4. In the case, physical transmission lines, such as twisted pair cables, coaxial cables, or optical cables, may be provided between core routers, between edge routers, or between a core router and an edge router. A core router positioned along a pseudowire (a point-to-point link) determines a forwarding destination of a packet received from an edge router or another core by referring to a tunnel label contained in the received packet. The core router changes the tunnel label contained in the packet into a value corresponding to the determined forwarding destination, and transfers the packet to the determined forwarding destination.

In the example depicted in FIG. 1, four edge routers are provided for the communication system 1. However, the number of edge routers provided for the communication system 1 is not limited to four. A communication system 1 may be configured to include the appropriate number of edge routers in accordance with the specification required for the communication system 1.

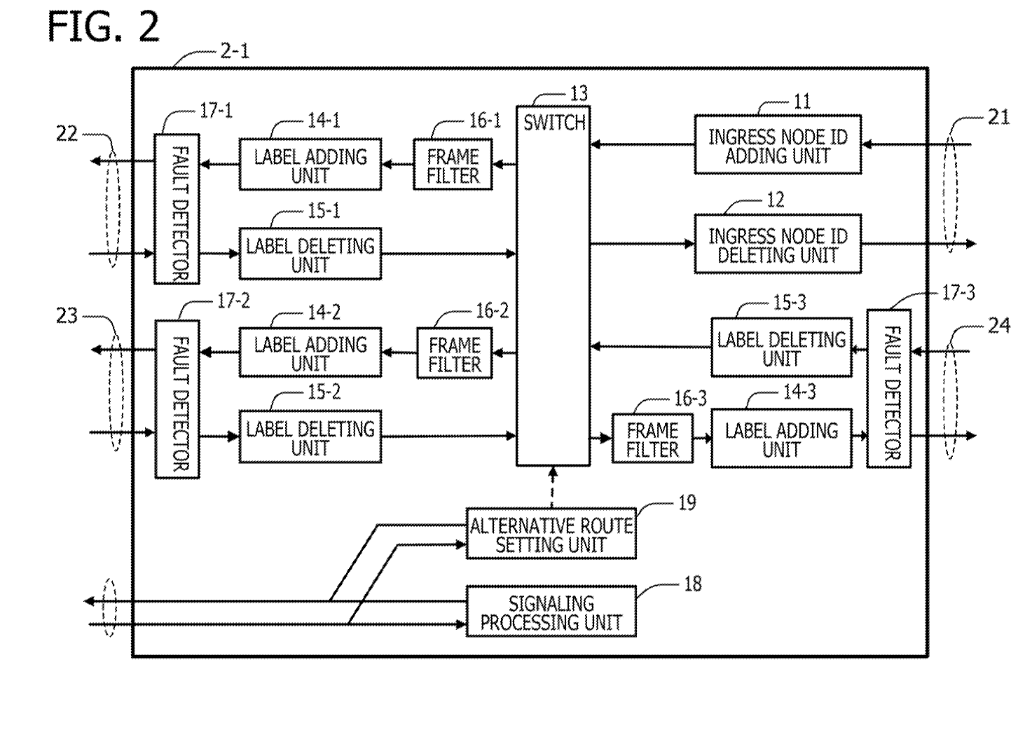

FIG. 2 is a diagram illustrating a configuration example of an edge router, according to an embodiment. In the example depicted in FIG. 2, the configuration of the edge router 2-1 in FIG. 1 is depicted as a representative example of an edge router according to an embodiment. The edge routers 2-2 to 2-4 each has the same configuration as the edge router 2-1 except that pseudowires and a user network coupled thereto are different from the edge router 2-1. Therefore, the detailed explanation for the edge routers 2-2 to 2-4 is not described here.

The edge router 2-1 includes an ingress node ID adding unit 11, an ingress node ID deleting unit 12, a switch 13, label adding units 14-1 to 14-3, label deleting units 15-1 to 15-3, frame filters 16-1 to 16-3, fault detectors 17-1 to 17-3, signaling processing unit 18, and an alternative route setting unit 19. Each of the above mentioned units included in the edge router 2-1 may be configured as a different circuit. Also, the edge router 2-1 may be configured to include an integrated circuit that integrates circuits having functions corresponding to the above mentioned units. Further, each of the above mentioned units included in the edge router 2-1 may be configured as a functional module implemented by a computer program that is performed on one or more processors implemented in the edge router 2-1.

The label adding unit 14-1, the label deleting unit 15-1, the frame filter 16-1, and the fault detector 17-1 perform processing on a packet to be forwarded to the pseudowire 3-1 or a packet received from the pseudowire 3-1. Similarly, the label adding unit 14-2, the label deleting unit 15-2, the frame filter 16-2, and the fault detector 17-2 perform processing on a packet to be forwarded to the pseudowire 3-2 or a packet received from the pseudowire 3-2. Further, the label adding unit 14-3, the label deleting unit 15-3, the frame filter 16-3, and the fault detector 17-3 perform processing on a packet to be forwarded to the pseudowire 3-3 or a packet received from the pseudowire 3-3. Here, the number of label adding units, the number of label deleting units, and the number of frame filters are all equal to the number of pseudowires coupled to the edge router 2-1. Accordingly, the number of label adding units, the number of label deleting units, the number of frame filters, and the number of fault detectors all increase as the number of pseudowires coupled to the edge router 2-1 increase.

Further, the edge router 2-1 is coupled to a user network 4-1 via an access port 21, and coupled to pseudowires 3-1 to 3-3 via access ports 22 to 24, respectively. These access ports 21 to 24 may be, for example, interface circuits coupled to physical transmission lines corresponding to the user network 4-1 and the pseudowires 3-1 to 3-3. Here, the access ports 22 to 24 may be configured as different interface circuits or as one interface circuit.

The ingress node ID adding unit 11, upon receiving as a MAC frame (a first packet) from the user network 4-1 via the access port 21, adds the identification number of the edge router 2-1 to the received MAC frame (a second packet). The ingress node ID is an identification number identifying an edge router that is positioned at the entrance of the virtual private network provided by the communication system 1, and unique to each of edge routers. In the case, for example, identification numbers of the edge routers 2-1 to 2-4 may be set at values “1” to “4”, respectively. The ingress node ID adding unit 11 sends the MAC frame containing the ingress node ID (the second packet) to the switch 13. Hereinafter, a packet that is received from a user network and does not include in ingress node ID is expressed also as “a first packet”, and a packet that includes an ingress node ID and forwarded among edge routers via point-to-point links (for example, pseudowires) is expressed also as “a second packet”. Also hereinafter, examples are described using a MAC frame as a representative example for a packet, and expressions “(a first packet)” or “(a second packet)” are added, if needed, in order to clarify whether the MAC frame is a first packet or a second packet.

The ingress node ID deleting unit 12 deletes the ingress node ID from the MAC frame, received from the switch 13, that includes the ingress node ID. The ingress node ID deleting unit 12 transmits a MAC frame from which the ingress node ID has been deleted (a first packet) to the user network 4-1 via the access port 21.

The switch 13 learns a transferring destination corresponding to a MAC address by referring to destination information and source information contained in the MAC frame (a second packet) received by the edge router 2-1. Then, the switch 13 updates a routing table in which a MAC address is associated with a pseudowire corresponding to the MAC address, and stores the updated routing table in the memory of the switch 13. Upon receiving a MAC frame including an ingress node ID (a second packet) from the ingress node ID adding unit 11 or the label deleting units 15-1 to 15-3, the switch 13 determines a transferring destination corresponding to the destination MAC address contained in the received MAC frame (a second packet) by referring to the routing table. The switch 13 transfers the MAC frame (a second packet) to the frame filters 16-1 to 16-3 or the ingress node ID deleting unit 12 that corresponds to an access port corresponding to the forwarding destination, along with the identifier identifying a pseudowire or an user network from which the MAC frame (a second packet) has been received. Here, an identification number assigned to each pseudowire or a user network may be used as an identifier identifying a pseudowire or a user network. Further, an identification number of an access port to which each pseudowire or a user network is coupled, may be used as an identifier identifying a pseudowire or a user network.

In the routing table, an entry having transferring destination information indicating a pseudowire on which a fault occurrence has been detected, may be deleted by the alternative route setting unit 19. In the case, the switch 31 floods the MAC frame (a second packet) towards all the pseudowires except the pseudowire on which the fault occurrence has been detected, when there exist no entries in the forwarding table that contain the transferring destination information corresponding to the destination MAC address stored in the MAC frame (a second packet). In other words, the switch 31 transfers the MAC frame (a second packet) to all the frame filters corresponding to the pseudowires except the faulty pseudowire.

The label adding units 14-1 to 14-3 receive a MAC frame including an ingress node ID (a second packet) from the frame filters 16-1 to 16-3, respectively. Each of the label adding units 14-1 to 14-3 creates a MPLS packet by adding to the received MAC frame a label for controlling data transmission in a MPLS network. In the case, each of the label adding units 14-1 to 14-3 adds, to the MAC frame including an ingress node ID (a second packet), a tunnel label for a MPLS tunnel and a PW label for a pseudowire. Thereafter, the label adding units 14-1 to 14-3 transmit the created MPLS packets to the pseudowires 3-1 to 3-3 via the fault detector 17-1 to 17-3, respectively. It is also possible that the label adding units 14-1 to 14-3 are configured to transmit the created packets to the pseudowires 3-1 to 3-3, respectively, without using the fault detector 17-1 to 17-3.

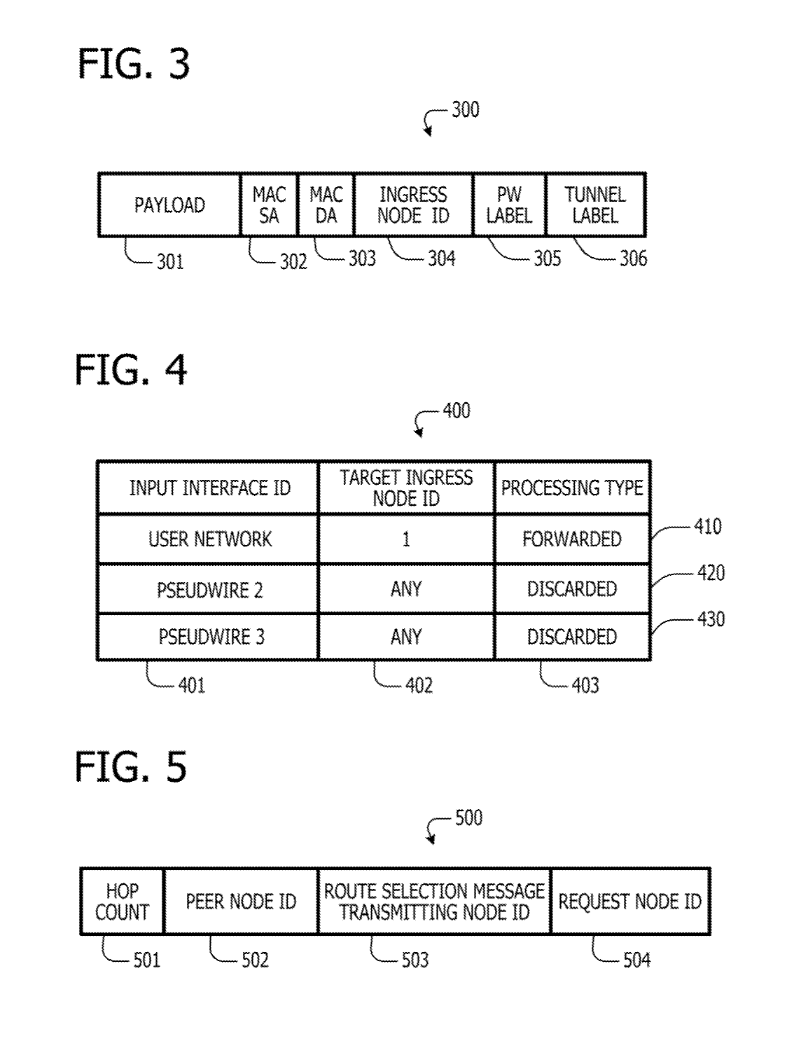

FIG. 3 is a diagram illustrating an example of a second packet that is forwarded in a communication system, according to an embodiment. A packet 300 includes a payload 301, a source MAC address (MAC SA) 302, a destination MAC address (MAC DA) 303, an ingress node ID 304, a PW label 305, and a tunnel label 306. The payload 301 contains data and header information included in the MAC frame. The source MAC address 302 contains a MAC address assigned to a communication device that has transmitted the MAC frame. The MAC address 303 contains a MAC address assigned to a communication device that is the destination of the MAC frame.

The label deleting units 15-1 to 15-3 extract MAC frames including ingress node ID (a second packets) from packets that have been received from the pseudowires 3-1 to 3-3 via the fault detectors 17-1 to 17-3, respectively. The label deleting units 15-1 to 15-3 may be also configured to receive the packets (a second packets) without using the fault detectors 17-1 to 17-3. Thereafter, the label deleting units 15-1 to 15-3 send the MAC frames including ingress node IDs (a second packets) to the switch 13 along with the identification numbers identifying the pseudowires or the user network via which the MAC frames (a second packet) have been received.

The frame filters 16-1 to 16-3 forward the MAC frames each containing an ingress node ID (a second packet), to the label adding units 14-1 to 14-3, respectively, or discard them (a second packet) based on forwarding control information held by the respective frame filters 16-1 to 16-3. As the forwarding control information, a filter table is stored in the respective frame filters 16-1 to 16-3. The filter table associates an input interface ID identifying an input interface from which the MAC frame is received and the target ingress node ID, with a processing method to be performed on the received MAC frame. Here, the target ingress node ID is used for determining whether the received a MAC frame (a second packet) is to be forwarded or discarded by comparing the ingress node ID contained in the received second packet with the target ingress node ID.

FIG. 4 is a diagram illustrating an example of a filter table, according to an embodiment. In the example of FIG. 4, a filter table 400 is depicted as a representative example for the filter table. The filter table includes one or more forwarding control records for controlling forwarding of a packet. In the example depicted in FIG. 4, the one or more forwarding control records are expressed as rows 410, 420, and 430, and a forwarding control record includes three fields named “INPUT INTERFACE ID”, “TRAGET INGRESS NODE ID”, and “PROCESSING TYPE”. The filter table 400 may be stored in a memory held by a frame filter 16-1. In the filter table 400, each cell of the leftmost column 401 (named “INPUT INTERFACE ID”) contains an input interface ID identifying a pseudowire or a user network from which the MAC frame (the second packet) is received. Each cell of the middle column 402 (denoted by “TARGET INGRESS NODE ID”) contains a target ingress node ID that is used for determining whether the received second packet is to be forwarded or discarded by comparing the ingress node ID contained in the second packet with the target ingress node ID. Each cell of the rightmost column 403 (denoted by “PROCESSING TYPE”) contains information identifying a processing method that is to be performed on the second packet. In the case, the processing method indicated by the cell of the column 403 may be performed on the received MAC frame (the second packet) by the frame filter 16-1. For example, when a “PROCESSING TYPE” of the forwarding control record is “FORWARDED”, the frame filter 16-1 forwards the second packet including the same ingress node ID as the target ingress node ID of the forwarding control record, to the label adding unit 14-1 so as to forward the second packet to the pseudowire 3-1. Meanwhile, when a “PROCESSING TYPE” of the forwarding control record is “DISCARDED”, the frame filter 16-1 discards the second packet including the same ingress node ID as the target ingress node ID of the forwarding control record. In this way, for each of the one or more forwarding control records of the filter table 400, processing method to be performed on the second packet including the same ingress node ID as the target ingress node ID of the forwarding control record is defined. Hereinafter, for convenience of explanation, when referring to the filter table, identification numbers corresponding to the pseudowires 3-1 to 3-6 may be expressed as pseudowires 1 to 6, respectively.

As depicted in FIG. 4, for example, according to the forwarding control record represented by the row 410, a MAC frame having an ingress node ID “1” identifying the edge router 2-1 is forwarded to the pseudowire 3-1 when the MAC frame has been received via the user network 4-1. Also, according to the forwarding control record represented by the row 420, a MAC frame received via the pseudowire 3-2 is discarded regardless of the value of an ingress node ID added to the received MAC frame. Similarly, according to the forwarding control record represented by the row 430, a MAC frame received via the pseudowire 3-3 is discarded regardless of the value of an ingress node ID added to the received MAC frame.

When there exist no faults occurring in the pseudowires, a filter table included in each of the frame filters (for example, the pseudowires 16-1 to 16-3) is defined so that the split horizon is applied to a MAC frame received from any one of the pseudowires. That is, the filter table is defined so that only the MAC frame that is received from the user network and has an ingress node ID of “1” corresponding to the edge router 2-1 is forwarded to the pseudowire 3-1, as depicted in the filter table of FIG. 4. This allows the edge router 2-1 to prevent a packet (for example, a MAC frame) from looping in the communication system 1.

Meanwhile, when a fault has occurred on some pseudowires, a filter table held in the frame filter of each edge router positioned along an alternative communication route is changed so that the split horizon is not applied to a packet containing the MAC frame that has been received from a user network by a edge router accommodating the faulty pseudowire. That is, a frame filter positioned along the alternative communication route forwards a MAC frame that has been received via a pseudowire included in the alternative communication route and has an ingress node ID identifying an edge router coupled to the faulty pseudowire, to a next hop pseudowire included in the alternative communication route. This allows the communication system 1 to set an alternative communication route that bypasses the faulty pseudowire by utilizing the existing pseudowires.

The fault detectors 17-1 to 17-3 detect a fault occurrence on the pseudowires 3-1 to 3-3 by checking whether the edge router 2-1 is capable of communicating with the respective peer routers of the edge router 2-1. Here, one of a pair of edge routers coupled via a point-to-point link (for example, a pseudowire) is called “a peer edge router” of the other one of the pair of edge routers. In the case, the edge routers 2-2 to 2-4 are peer edge routers of the edge router 2-1 that are coupled to the edge router 2-1 via the pseudowires 3-1 to 3-3, respectively.

For example, the fault detector 17-1 transmits a keep-alive signal for checking a communication state to the peer edge router 2-2 via the pseudowire 3-1, at a given interval that is set beforehand. Also, the fault detector 17-1 receives, via the pseudowire 3-1, a keep-alive signal transmitted from the peer edge router 2-2 via the pseudowire 3-1. In the case, for example, the fault detector 17-1 determines that there exist no faults occurring on the pseudowire 3-1 when the keep-alive signal transmitted from the peer edge router 2-2 is received at the given interval. On the contrary, the fault detector 17-1 determines that a fault occurrence has been detected on the pseudowire 3-1 when no keep-alive signals are received from the edge router 2-2. Further, the fault detector 17-1 may be configured to determine that a fault occurrence has been detected on the pseudowire 3-1 when the interval at which keep-alive signals are received from the peer edge router 2-2 is different from the given interval at which the peer edge router 2-2 actually transmits keep-alive signals.

In a manner similar to the fault detector 17-1, the fault detector 17-2 transmits a keep-alive signal for checking a communication state to the peer edge router 2-3 via the pseudowire 3-2 at a given interval that is set beforehand, and receives, via the pseudowire 3-2, a keep-alive signal transmitted at a given interval from the peer edge router 2-3. The fault detector 17-2 determines whether or not a fault occurrence has been detected on the pseudowire 3-2 by checking whether the keep-alive signal transmitted from the peer edge router 2-3 is received at the given interval or not.

Similarly, the fault detector 17-3 transmits a keep-alive signal for checking a communication state to the peer edge router 2-4 via the pseudowire 3-3 at a given interval that is set beforehand, and receives, via the pseudowire 3-3, a keep-alive signal transmitted at a given interval from the peer edge router 2-4. The fault detector 17-3 determines whether or not a fault occurrence has been detected on the pseudowire 3-3 by checking whether the keep-alive signal transmitted from the edge router 2-4 is received at the given interval or not.

When a fault detector (in the case, one of the fault detectors 17-1 to 17-3) has detected a fault occurrence on the corresponding pseudowire (in the case, pseudowires 3-1 to 3-3 correspond to the fault detectors 17-1 to 17-3, respectively), the fault detector send, to the alternative route setting unit 19, a signal indicating a fault occurrence and an identifier identifying the pseudowire on which the fault occurrence has been detected. Further, upon detecting recovery of the faulty pseudowire, the fault detector that detected the fault occurrence sends, to the alternative route setting unit 19, a signal indicating the recovery of the fault occurrence and an identifier identifying the pseudowire on which the fault occurrence has been recovered.

The signaling processing unit 18 performs a signaling processing so that labels used for MPLS tunnels and PW labels used for pseudowires are set to each of the edge routers and core routers in the MPLS network. The signaling processing unit 18 performs the signaling processing, based on signaling protocols, such as a Label Distribution Protocol (LDP) or a Bordedr Gateway Protocol (BGP). Here, the signaling processing unit 18 exchanges messages between the edge router 2-1 and other edge routers or core routers, by transmitting/receiving the messages to/from an IP network in which the communication system 1 may be implemented.

An alternative route setting unit 19 of the edge router 2-1 is configured to set, upon detecting a fault occurrence on one of the psuedowires coupled to the edge router 2-1, an alternative communication route for the faulty pseudowire on which the fault occurrence has been detected. Here, the alternative route setting unit 19 creates a route selection message for requesting edge routers other than the edge router 2-1 and the peer edge router coupled via the faulty pseudowire, to select and set the alternative communication route. Here, the route selection message is a type of message for relaxing the inhibition of a packet from being forwarded among a plurality of point-to-point links. The alternative route setting unit 19 transmits the route selection message to the edge routers other than the edge router 2-1 and the peer edge router coupled via the faulty pseudowire, for example, via an IP network. This allows edge routers other than the edge router 2-1 and the peer edge router coupled via the faulty pseudowire, to relax the inhibition of a packet from being forwarded among a plurality of pseudowires, and to set an alternative communication route for the faulty paseudowire.

Meanwhile, when a fault occurrence has been detected on a pseudowire which is used for exchanging MPLS packets by edge routers other than the edge router 2-1, the alternative route setting unit 19 of the edge router 2-1 receives a route selection message from edge routers other than the edge router 2-1 via the IP network. Then, the alternative route setting unit 19 of the edge router 2-1 sets an alternative communication route by updating the filter table thereof so as to cancel the split horizon imposed on a packet that is transmitted from the user network of the edge router coupled to the faulty pseudowire.

FIG. 5 is a diagram illustrating an example of a route selection message, according to an embodiment. A route selection message 500 includes a hop count 501, a peer node identifier 502, a route selection message transmitting node identifier 503, and request node identifier 504.

The hop count 501 indicates the number of intermediate edge routers positioned along the alternative communication route. For example, it is assumed that an alternative communication route passing through the pseudowires 3-1, 3-3 is set when a fault occurrence has been detected on the pseudowire 3-5. In the case, the hop count 501 indicates “1” since only the edge router 2-1 is an intermediate edge router positioned along the alternative communication route coupling the edge routers 2-2, 2-4 through the pseudowires 3-1, 3-3. In another case, it is assumed that an alternative communication route passing through the pseudowire 3-1, 3-2, 3-6 is set when a fault occurrence has been detected on the pseudowire 3-5. In the case, there exist two intermediate edge routers of the edge rooters 2-1, 2-3 positioned along the alternative communication route. Therefore, a hop count 501 indicates “2” for this alternative communication route. Further, a hop count 501 is decremented by “1” every time the route selection message is transferred by an edge router.

The peer node ID 502 identifies a peer node of the faulty pseudowire, that does not issue a request for setting an alternative communication route. Hereinafter, out of a pair of edge routers coupled by the pseudowire on which a fault has occurred, an edge router that issues a request for setting an alternative communication route is referred to as “a request node” of the faulty pseudowire, and the other edge router that does not issue a request for setting an alternative communication route is referred to as “a peer node” of the faulty pseudowire. That is, one of a pair of edge routers coupled via the faulty point-to-point link is determined to be a request node of the faulty point-to-point link, and the other one is determined be a peer node of the faulty point-to-point link. The request node transmits a route selection message to edge routers other than the request and peer nodes of the faulty point-to-point link. For example, in FIG. 1, it is assumed that the edge router 2-2 is a request node of the pseudowire 3-5 coupling the edge routers 2-2, 2-4. In the case, the peer node ID 502 identifies the edge router 2-4 as a peer node of the pseudowire 3-5.

The route selection message transmitting node ID 503 identifies the edge router that has actually transmitted the route selection message 500. Therefore, the route selection message transmitting node ID 503 indicates a different value every time the route selection message 500 is transferred by each of edge routers. For example, in FIG. 1, it is assumed that the edge router 2-2 firstly transmitted a route selection message when a fault occurrence has been detected on the pseudowire 3-5. In the case, the route selection message transmitting node ID 503 identifies the edge router 2-2. Next, it is assumed that the edge router 2-1 received the route selection message from the edge router 2-2 and transferred the route selection message to the edge router 2-3. In the case, the route selection message transmitting node ID 503 identifies the edge router 2-1.

The request node ID 504 identifies a request node of the faulty pseudowire. In other words, the request node ID 504 identifies an edge router that has firstly sent a route selection message 500. For example, in FIG. 1, it is assumed that the edge router 2-2 is a request node when a fault occurrence has been detected on the pseudowire 3-5. In the case, the request node ID 504 identifies the edge router 2-2.

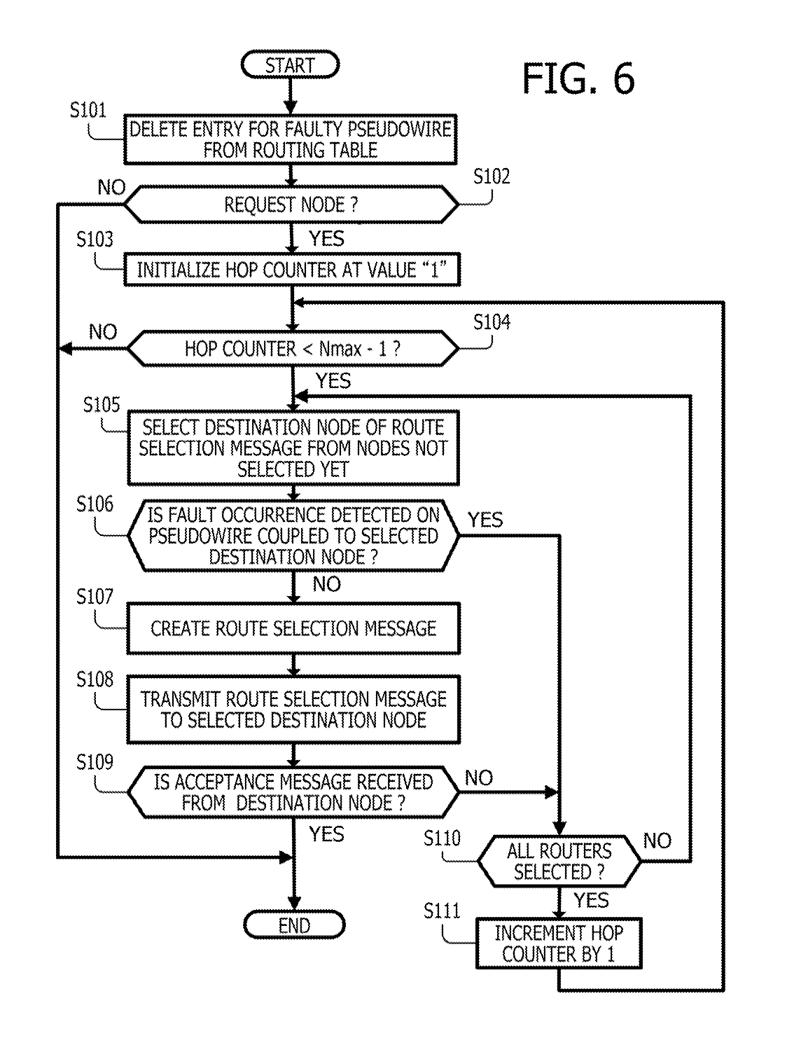

FIG. 6 is a diagram illustrating an example of an operational flowchart for setting an alternative communication route, according to an embodiment. In the example of FIG. 6, an operational flowchart for an alternate route setting unit 19 of a request node is depicted. In the case, when the request node has detected a fault occurrence on a point-to-point link (for example, a pseudowire) that is operated in a normal state, the alternate route setting unit 19 of the request node requests one or more edge routers other than the request and peer node of the faulty point-to-point link, to select and set an alternative communication route for the point-to-point link. In FIG. 6, for convenience of explanation, each of operations for setting an alternative communication route is expressed as a step, and sequence numbers from S101 to S111 are assigned to the steps.

Upon receiving, from one of the fault detectors 17-1 to 17-3, a signal indicating a fault occurrence and an identifier identifying the pseudowire on which the fault occurrence has been detected, the alternative route setting unit 19 of the edge router coupled to the faulty pseudowire, starts selection and setting of an alternative communication route. In step S101, the alternative route setting unit 19 of the edge router deletes all the entries having a forwarding address corresponding to the faulty pseudowire from a routing table stored in the switch 13 of the edge router.

In step S102, the alternative route setting unit 19 of the edge router determines whether the edge router is a request node of the faulty pseudowire or not. Here, it is assumed that, for each of the pseudowires, the corresponding request node is set beforehand based on a given regulation. For example, among two edge routers coupled by a given pseudowire, the edge router having an identification number smaller than the other edge router may be set as a request node of the given pseudowire.

The alternative route setting unit 19 ends processing when the edge router is not a request node of the faulty pseudowire (NO in step S102). Thus, among two edge routers coupled by the faulty pseudowire, only one edge router performs an alternative communication route setting process, thereby preventing the communication system 1 from doubly setting alternative communication routes for the one faulty pseudowire.

Meanwhile, when the edge router is a request node of the faulty pseudowire (YES in step S102), the alternative route setting unit 19 initializes a trial hop counter at the value “1” (in step S103). In the case, a value of the trial hop counter is set to a hop count of the route selection message.

In step S104, the alternative route setting unit 19 determines whether or not the value of the trial hop counter is less than the value obtained by subtracting “1” from the value “Nmax−1” which is the number of edge routers included in the communication system 1. When the value of the trial hop counter is equal to or greater than the value “Nmax−1” (NO in step S104), the alternative route setting unit 19 ends processing without selecting an alternative communication route. This is because that an alternative communication route having a hop count equal to or greater than “Nmax−1” cannot exist in the communication system 1 since request and peer nodes of the faulty pseudowire cannot be an intermediate edge router constituting an alternative communication route coupling for the faulty pseudowire.

Meanwhile, when the value of the trial hop counter is less than the value “Nmax−1” (YES in step S104), the alternative route setting unit 19 selects a destination edge router (abbreviated as “destination node”) to which the route selection message is to be transmitted. For example, the alternative route setting unit 19 selects the destination edge router from a set of edge routers each having a node selection flag of “OFF” (in step S105). Here, the node selection flag indicates whether or not the corresponding edge router has been selected as a destination node of the route selection message. The value “ON” means that the corresponding edge router has been selected as a destination node of the route selection message, and the value “OFF” means that the corresponding edge router has not been selected as a destination node of the route selection message. At the same time, the alternative route setting unit 19 set the value “ON” to the node selection flag corresponding to the selected destination node, and stores the node selection flag into a memory of the alternative route setting unit 19.

In step S106, the alternative route setting unit 19 determines whether or not a fault occurrence has been detected on the pseudowire coupling the edge router and the destination edge router. Here, for example, the alternative route setting unit 19 determines that a fault occurrence has been detected on the pseudowire when receiving, from the corresponding fault detector, an identification number of the pseudowire coupling the edge router and the destination edge router, and a signal indicating that a fault has occurred on the pseudowire.

When a fault occurrence has been detected on the pseudowire coupling the edge router and the destination edge router (YES in step S106), the alternative route setting unit 19 proceeds to step S110.

Meanwhile, when a fault has not been detected on the pseudowire coupling the edge router and the destination edge router (NO in step S106), the alternative route setting unit 19 creates a route selection message (in step S107). Here, the alternative route setting unit 19 sets the value of the trial hop counter to the hop count 501 of the route selection message 500. Further, the alternative route setting unit 19 sets an identification number of the peer node (IDpeer) of the faulty pseudowire to the peer node ID 502 of the route selection message 500. Furthermore, the alternative route setting unit 19 sets the identification number of the edge router (IDrequest) to both the route selection message transmitting node ID 503 and the request node ID 504 of the route selection message 500. Thereafter, the alternative route setting unit 19 transmits the created route selection message to the destination edge router (in step S108).

In step S109, the alternative route setting unit 19 determines whether or not a route selection acceptance message is received from the destination edge router via the IP network. Here, the route selection acceptance message is returned from the destination edge router when the destination edge router has selected a communication route capable of communicating with the peer node of the faulty pseudowire. In the case, the alternative route setting unit 19 may be configured to put a waiting time depending on the value of the trial hop counter, between the end of the step S108 and the beginning of the step S109.

Upon receiving the route selection acceptance message from the destination edge router (YES in step S109), the alternative route setting unit 19 stores the current value of the trial hop counter, as the number of hops for the alternative communication route, into a memory held by the alternative route setting unit 19. Thereafter, the alternative route setting unit 19 completes the process for selecting and setting the alternative communication route for the faulty pseudowire.

Upon receiving a route selection rejecting message from the destination edge router (NO in step S109), the alternative route setting unit 19 determines whether or not all the edge routers, except the edge router and the peer edge router, have been selected as a destination node (in step S110). Here, the route selection rejecting message is returned from the destination edge router when the destination edge router has failed to select a communication route capable of communicating with the peer node of the faulty pseudowire. In the case, for example, the alternative route setting unit 19 can determine that an edge router has been already selected as a destination edge router when the node selection flag corresponding to the edge router is set at the value “ON”.

When there exist one or more edge routers that have not been selected as a destination node (NO in step S110), the alternative route setting unit 19 repeat the operations from the step S105 to the step S110 until all the relevant edge routers have been selected as a destination node. Meanwhile, when all the relevant edge routers have been selected as a destination node (YES in step S110), the alternative route setting unit 19 increments the trial hop counter by “1” (in step S111). Here, the alternative route setting unit 19 set a value “OFF” to the node selection flags corresponding to all the edge routers except the edge router and the peer edge router. Thereafter, the alternative route setting unit 19 repeat the operations from the step S104 to the step S111 until the value of the trial hop counter becomes equal to or greater than the value “Nmax−1”.

Upon detecting fault occurrences on a plurality of pseudowires at the same time, the alternative route setting unit 19 performs the above mentioned operations depicted in FIG. 6 for each of the plurality of the faulty pseudowires.

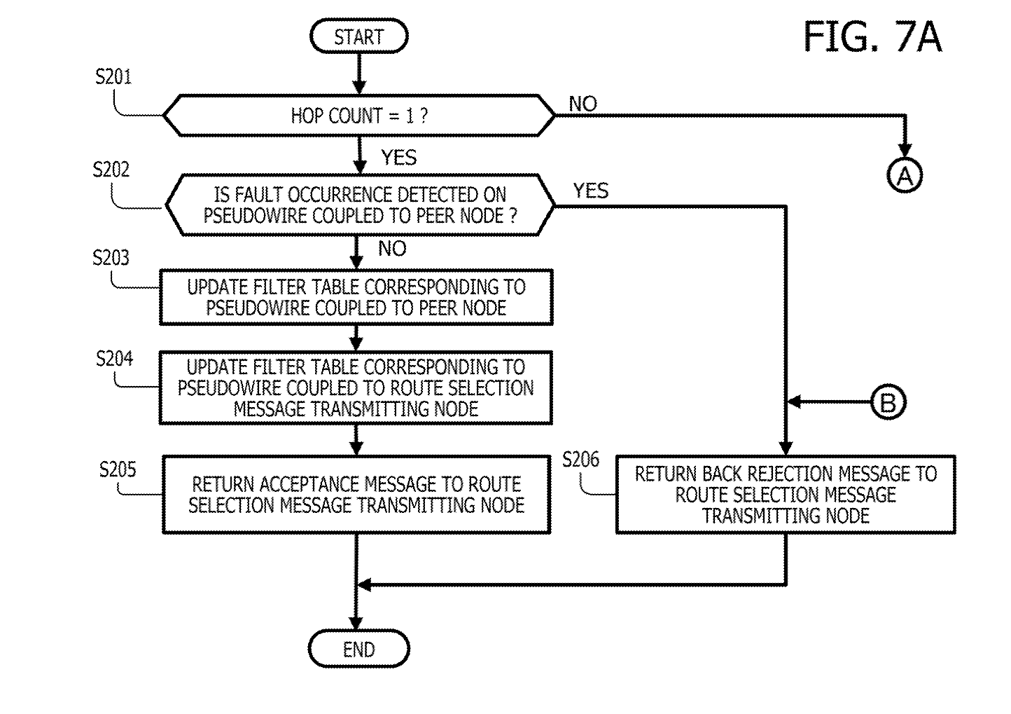

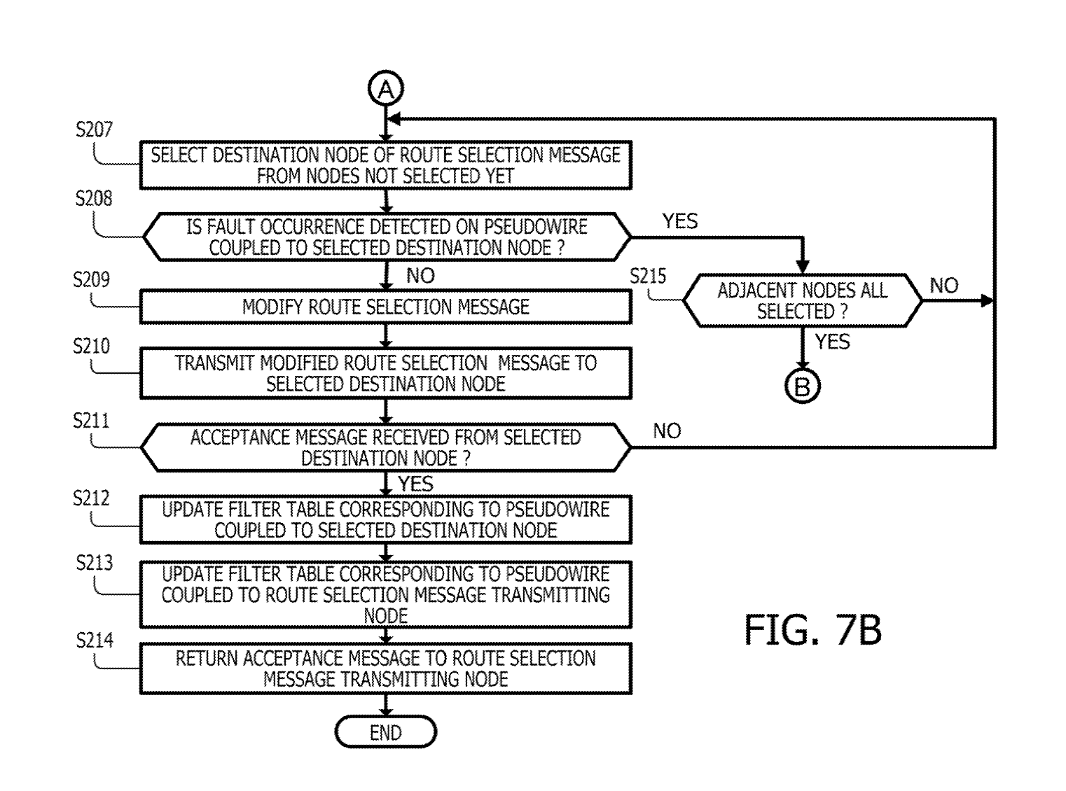

FIG. 7 is a diagram illustrating an example of an operational flowchart for setting an alternative communication route, according to an embodiment. In the example of FIG. 7, an operational flowchart for an alternate route setting unit 19 of an edge router that has received a route selection message from the request node is depicted. In the case, when the request node has detected a fault occurrence on the pseudowire that is operated in a normal state, the alternate route setting unit 19 of the request node requests one or more edge routers other than the request and peer nodes of the faulty pseudowire (point-to-point link), to select and set an alternative communication route for the faulty pseudowire. In FIG. 7, for convenience of explanation, each of operations for selecting and setting an alternative communication route is expressed as a step, and sequence numbers from S201 to S215 are assigned to the steps.

In step S201, upon receiving a route selection message, the alternative route setting unit 19 of an edge router determines whether the value of the hop count 501 included in the received route selection message is equal to “1” or not. When the value of the hop count 501 is equal to “1” (YES in step S201), the alternative route setting unit 19 further determines whether or not a fault occurrence has been detected on the pseudowire coupled to the peer router (in step S202). Here, the alternative route setting unit 19 determines that a fault has occurred on a pseudowire coupled to the peer router when receiving, from the corresponding fault detector, the identification number of the pseudowire and a signal indicating that a fault has occurred on the pseudowire.

Upon detecting a fault occurrence on the pseudowire coupled to the peer router (YES in step S202), the alternative route setting unit 19 returns back a route selection rejecting message to the route selection message transmitting node (in step S206).

Meanwhile, when it is determined that a fault occurrence has not been detected on the pseudowire coupled to the peer node (NO in step S202), that is, the edge router is capable of communicating with the peer node, the alternative route setting unit 19 updates a filter table of the frame filter corresponding to the pseudowire coupled to the peer node (in step S203). For example, the alternative route setting unit 19 updates the filter table so that a packet that has been received from a pseudowire coupled to the route selection message transmitting node and has an ingress node ID identifying the request node, is forwarded to a pseudowire coupled to the peer node.

Further, the alternative route setting unit 19 of the edge router updates a filter table of the frame filter corresponding to a pseudowire coupled to the route selection message transmitting node (in step S204). For example, the alternative route setting unit 19 updates the filter table so that a packet that has been received from a pseudowire coupled to the peer node of the faulty pseudowire and has an ingress node ID identifying the peer node, is forwarded to a pseudowire corresponding to the filter table

In step S205, the alternative route setting unit 19 returns a route selection acceptance message to the route selection message transmitting node.

After operation represented by the steps S205 or S206, the alternative route setting unit 19 ends a process of selecting and setting an alternative communication route for the faulty pseudowire.

In step S201, when the value of the hop count included in the received route selection message is greater than “1” (NO in step S201), the alternative route setting unit 19 selects a destination of the route selection message (in step S207), as depicted in FIG. 7B. For example, the alternative route setting unit 19 selects a destination node to which the route selection message to be transmitted, from among edge routers each having, as a node selection flag, the value “OFF”. Here, the alternative route setting unit 19 does not selects, as the destination node, the request router, the peer router, the route selection transmitting node, and the own router. This is because that these edge routers previously used the faulty pseudowire or have performed processing on setting of the alternative communication route. Thereafter, the alternative route setting unit 19 sets the value “ON” to the node selection flag corresponding to the selected destination node, and stores the node selection flag in a memory of the alternative route setting unit 19.

In step S208, the alternative route setting unit 19 determines whether or not a fault occurrence has been detected on a pseudowire coupled to the destination node. When the fault occurrence has been detected on the pseudowire coupled to the destination node (YES in step S208), the alternative route setting unit 19 further determines whether or not all the adjacent edge routers have been selected as an destination node (in step S215). When there exists an edge router that has not been selected as a destination node (NO in step 215), the alternative route setting unit 19 proceeds to the step S207.

When the fault occurrence has not been detected on the pseudowire coupled to the destination node (NO in step S208), the alternative route setting unit 19 modifies the route selection message (in step S209). For example, the alternative route setting unit 19 modifies the received route selection message so that the value of the hop count 501 is decremented by 1 and the identification number of the own router is set to the route selection message transmitting node ID 503 thereof.

In step S210, the alternative route setting unit 19 transmits the modified route selection message to the selected destination node.

In step S211, the alternative route setting unit 19 determines whether or not a route selection acceptance message has been received from the destination node. Here, the alternative route setting unit 19 may be configured to put a waiting time depending on the value of the hop count 501 of the modified route selection message, between the end of the step S210 and the beginning of the step S211.

The alternative route setting unit 19, upon receiving the route selection acceptance message from the destination node (YES in step S211), updates a filter table held in the frame filter corresponding to the pseudowire coupled to the destination node (in step S212). For example, the alternative route setting unit 19 updates the filter table so that a packet that has received from the pseudowire coupled to the route selection message transmitting node and has an ingress node ID identifying the request node, is forwarded to the pseudowire coupled to the destination node.

The alternative route setting unit 19 further updates a filter table held in a frame filter corresponding to the pseudowire coupled to the route selection message transmitting node (in step S213). For example, the alternative route setting unit 19 updates the filter table so that a packet that has received from a pseudowire coupled to the selected destination node and has an ingress node ID identifying the peer node of the faulty pseudowire, is forwarded to a pseudowire coupled to the route selection message transmitting node.

In step S214, the alternative route setting unit 19 returns a route selection acceptance message to the route selection message transmitting node.

After the step S214, the alternative route setting unit 19 ends processing for selecting and setting an alternative communication route for the faulty pseudowire.

The above mentioned operational flowchart is an example for selecting and setting an alternative communication route, and various modifications are possible. For example, the order of the steps S203 to S205 may be changed. Similarly, the order of the steps S212 to S214 may be changed.

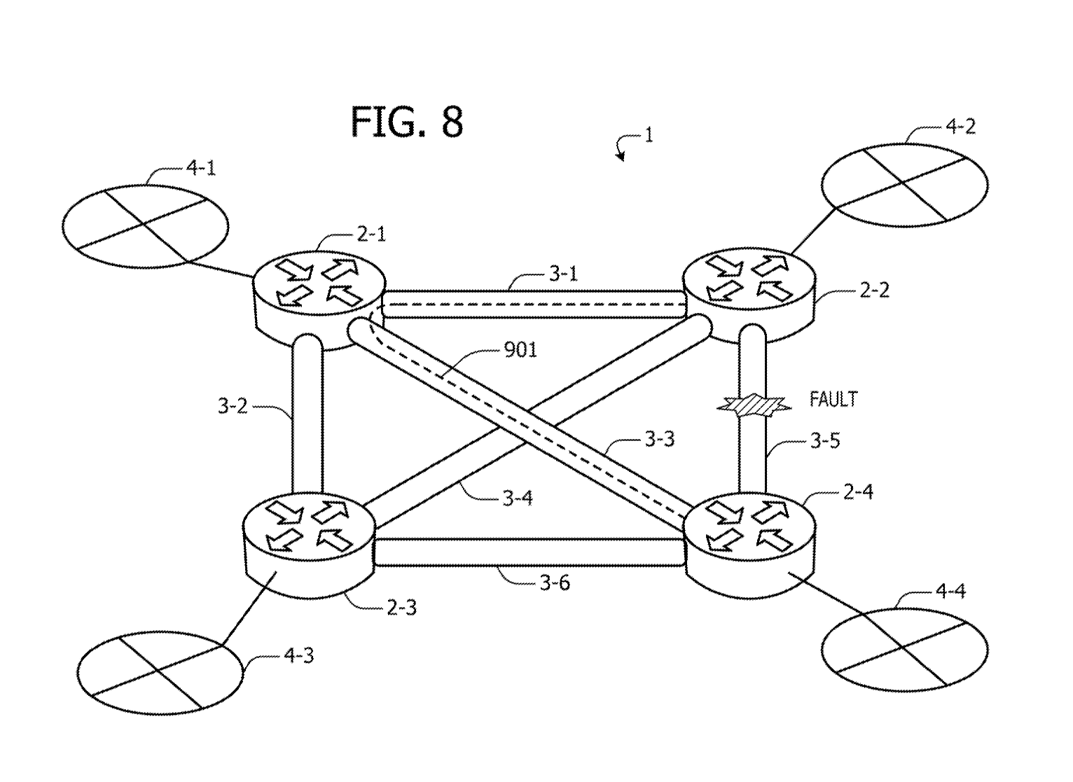

FIG. 8 is a diagram illustrating an example of an alternative communication route when a fault occurrence has been detected on a point-to-point link, according to an embodiment. FIG. 8 indicates the case when a fault has occurred on the pseudowire 3-5 coupling the edge routers 2-2 and 2-4 in the communication system 1 of FIG. 1. In the case, for example, the edge router 2-2 becomes a request router and performs the processing described in FIG. 6. The edge router 2-2, for example, becomes a request node of the faulty pseudowire, and transmits a route selection message to the edge router 2-1. In the case, in the route selection message, the hop count 501 is set at “1”, and the peer node ID 502 is set at “4” identifying the edge router 2-4. Further, the route selection message transmitting node ID 503 and the request node ID 504 are both set at “2” identifying the edge router 2-2.

Meanwhile, upon receiving a route selection message from the edge router 2-2, the edge router 2-1 performs the process as described in FIGS. 7A and 7B. As a result, a virtual communication path 901 (a dotted line depicted in FIG. 8) that passes through the pseudowire 3-1, the edge router 2-1, and the pseudowire 3-3 is selected and set as an alternative communication route for the faulty pseudowire 3-5, as depicted in FIG. 8.

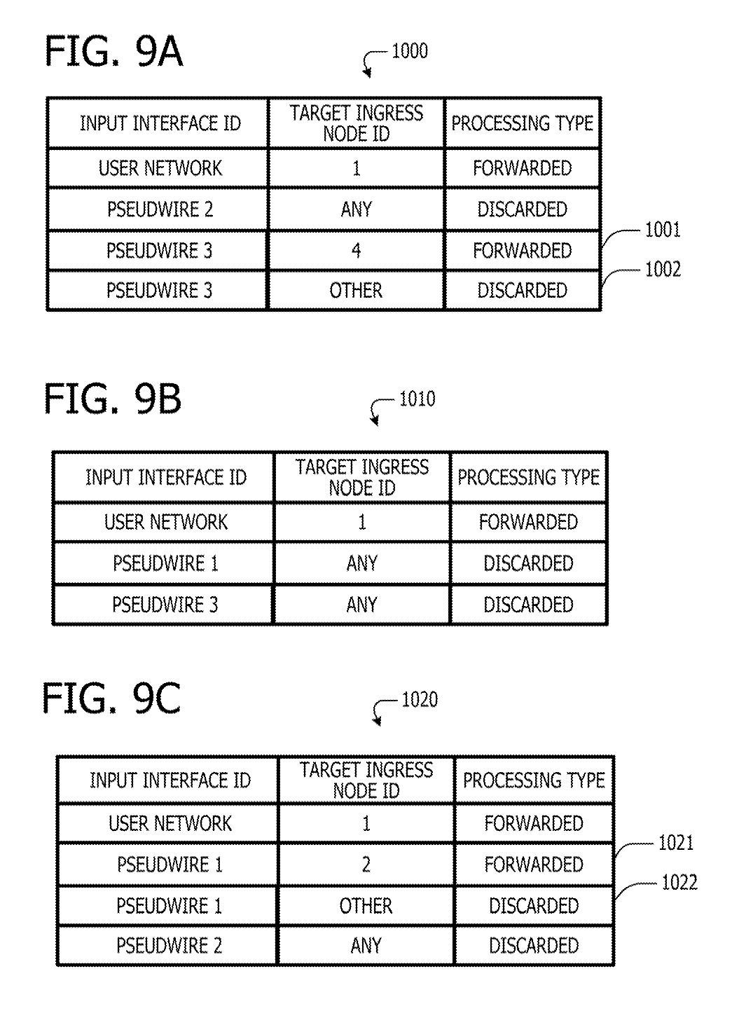

FIGS. 9A, 9B, 9C are diagrams illustrating examples of filter tables held by an edge router positioned along an alternative communication route, according to an embodiment. In FIGS. 9A, 9B, 9C, examples of filter tables held in the edge router 2-1 positioned along an alternative communication route 901 are depicted. A filter table 1000 of FIG. 9A is a filter table corresponding to the pseudowire 3-1. A filter table 1010 of FIG. 9B is a filter table corresponding to the pseudowire 3-2. Further, a filter table 1020 of FIG. 9C is a filter table corresponding to the pseudowire 3-3.

In a manner similar to the filter table 400 depicted in FIG. 4, each cell of the leftmost columns (named “INPUT INTERFACE ID”) of filter tables 1000, 1010, and 1020 contains an input interface ID identifying a pseudowire or a user network from which the MAC frame (a second packet) is received. Each cell of the middle column 402 (denoted by “TARGET INGRESS NODE ID”) contains a target ingress node ID that is used for determining whether the received packet (a second packet) is to be forwarded or discarded by comparing the ingress node ID contained in the received packet with the target ingress node ID. Each cell of the rightmost columns (denoted by “PROCESSING TYPE”) contains information identifying a processing method that is to be performed on the received MAC frame.

For example, the row 1001 of the filter table 1000 indicates that a MAC frame (a second packet) that is received from the pseudowire 3-3 and having an ingress node ID “4” identifying the edge router 2-4 should be forwarded to the pseudowire 3-1. The row 1002 indicates that a MAC frame (a second packet) that is received from the pseudowire 3-3 and having an ingress node ID identifying an edge router other than the edge router 2-4 should be discarded.

Similarly, the row 1021 of the filter table 1020 indicates that a MAC frame (a second packet) that is received from the pseudowire 3-1 and having an ingress node ID “2” identifying the edge router 2-2 should be forwarded to the pseudowire 3-3. The row 1022 indicates that a MAC frame (a second packet) that is received from the pseudowire 3-1 and having an ingress node ID identifying an edge router other than the edge router 2-2 should be discarded.

The other rows other than the above mentioned rows in the filter tables 1000 to 1020 indicate that only the MAC frame (a second packet) that is received from the user network 4-1 and having an ingress node ID “1”identifying the edge router 2-1 should be forwarded to the corresponding pseudowire.

In this way, the filter tables 1000, 1010, 1020 are defined so that a split horizon is cancelled with respect to a MAC frame (a second packet) that is received from the user networks 4-2, 4-4 by the respective edge routers 2-2, 2-4 which are coupled by the faulty pseudowire 3-5. As a result, the edge routers 2-2 and 2-4 are capable of communicating with each other via an alternative communication route 901 passing through the pseudowire 3-1, the edge router 2-1, and the pseudowire 3-3, as depicted with dotted line in FIG. 8.

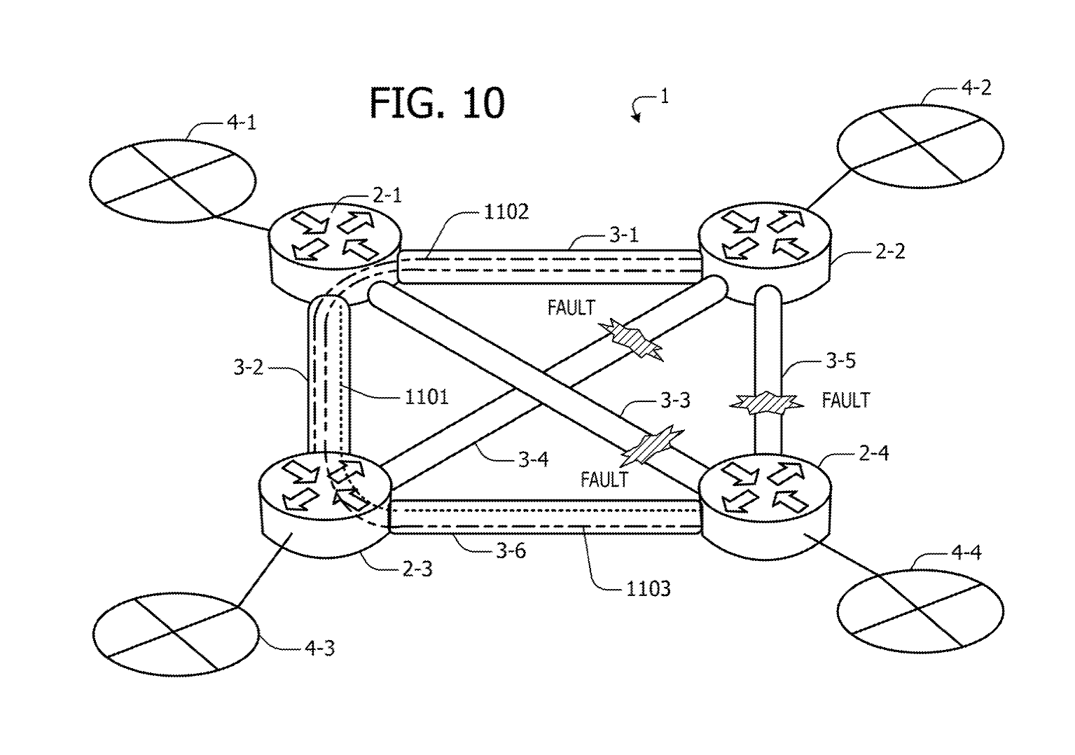

FIG. 10 is a diagram illustrating an example of an alternative communication route when a fault occurrence has been detected on a plurality of point-to-point links, according to an embodiment. FIG. 10 indicates the case when three faults have occurred on the pseudowire 3-3 coupling the edge routers 2-1 and 2-4, on the pseudowire 3-4 coupling the edge routers 2-2 and 2-3, and on the pseudowire 3-5 coupling the edge routers 2-2 and 2-4, in the communication system 1 of FIG. 1.

In the case, for example, the edge router 2-1 becomes a request node of the pseudowire 3-3 and performs the processing described in FIG. 6. The edge router 2-1 transmits a route selection message to the edge router 2-3. In the case, in the route selection message, the hop count 501 is set at “1”, and the peer node ID 502 is set at “4” identifying the edge router 2-4. Further, the route selection message transmitting node ID 503 and the request node ID 504 are both set at “1” identifying the edge router 2-1.

Meanwhile, the edge router 2-3, upon receiving a route selection message from the edge router 2-1, performs the processing described in FIGS. 7A, 7B. As a result, for example, a virtual communication path 1101 that passes through the pseudowire 3-2, the edge router 2-3, and the pseudowire 3-6 is set as an alternative communication route for the faulty pseudowire 3-3, as depicted with dotted line in FIG. 10.

As for the pseudowire 3-4, for example, the edge router 2-2 becomes a request node of the faulty pseudowire 3-4, and performs the processing depicted in FIG. 6. The edge router 2-2 transmits a route selection message to the edge router 2-1. In the case, in the route selection message, the hop count 501 is set at “1”, and the peer node ID 502 is set at “3” identifying the edge router 2-3. Further, the route selection message transmitting node ID 503 and the request node ID 504 are both set at “2” identifying the edge router 2-2

Meanwhile, the edge router 2-1, upon receiving a route selection message from the edge router 2-2, performs the processing described in FIGS. 7A and 7B. As a result, a virtual communication path 1102 that passes through the pseudowire 3-1, the edge router 2-1, and the pseudowire 3-2 is selected and set as an alternative communication route for the faulty pseudowire 3-4, as depicted with dashed-dotted line in FIG. 10.

As for the pseudowire 3-5, for example, the edge router 2-2 becomes a request node and performs the processing described in FIG. 6. The edge router 2-2 transmits a route selection message to the edge router 2-1. In the case, in the route selection message, the hop count 501 is set at “1”, and the peer node ID 502 is set at “4” identifying the edge router 2-4. Further, the route selection message transmitting node ID 503 and the request node ID 504 are both set at “2” identifying the edge router 2-2. However, in the case, the edge router 2-1 is not capable of communicating with the peer node of the faulty pseudowire 3-5 since there exists a fault occurrence on the pseudowire 3-3 coupling the edge routers 2-1 and 2-4. Therefore, there exist no alternative communication routes having a hop count “1” for the faulty pseudowire 3-5, that is, there exist no alternative communication routes in which the number of intermediate edge routers is “1”. As a result, the edge router 2-1 transmits a route selection rejecting message to the edge router 2-2 according to the process depicted in FIGS. 7A and 7B. The edge router 2-2, upon receiving the route selection rejecting message, again transmits a route selection message to the edge router 2-1 according to the processing depicted in FIG. 6. Here, the hop count 501 of the route selection message is set at “2” which is obtained by adding “1” to the hop count 501 contained in the firstly transmitted route selection message. The peer node ID 502 is set at “4” identifying the edge router 2-4 which is the same as that of the firstly transmitted route selection message. Further, the route selection message transmitting node ID 503 and the request node ID 504 are both set at “2” identifying the edge router 2-2, which is the same as those of the firstly transmitted route selection message. The edge router 2-1, upon receiving the route selection message resent from the edge router 2-2, modifies the received route selection message and transmits the modified route selection message to the edge router 2-3, according to the process described in FIGS. 7A, 7B. Further, the edge router 2-3, upon receiving the route selection message from the edge router 2-1, similarly executes the processing described in FIGS. 7A and 7B. As a result, a virtual communication path 1103 that passes through the pseudowire 3-1, the edge router 2-1, the pseudowire 3-2, the edge router 2-3, and the pseudowire 3-6 is selected and set as an alternative communication route for the faulty pseudowire 3-5, as depicted with dashed-two dotted line in FIG. 10. In the case, the route selection message that is transmitted from the edge router 2-1 to the edge router 2-3 is set as follows. The hop count 501 is set at “1”. The peer node ID 502 is set at “4” identifying the edge router 2-4. Further, the route selection message transmitting node ID 503 is set at “1” identifying the edge router 2-1, and the request node ID 504 is set at “2” identifying the edge router 2-2.

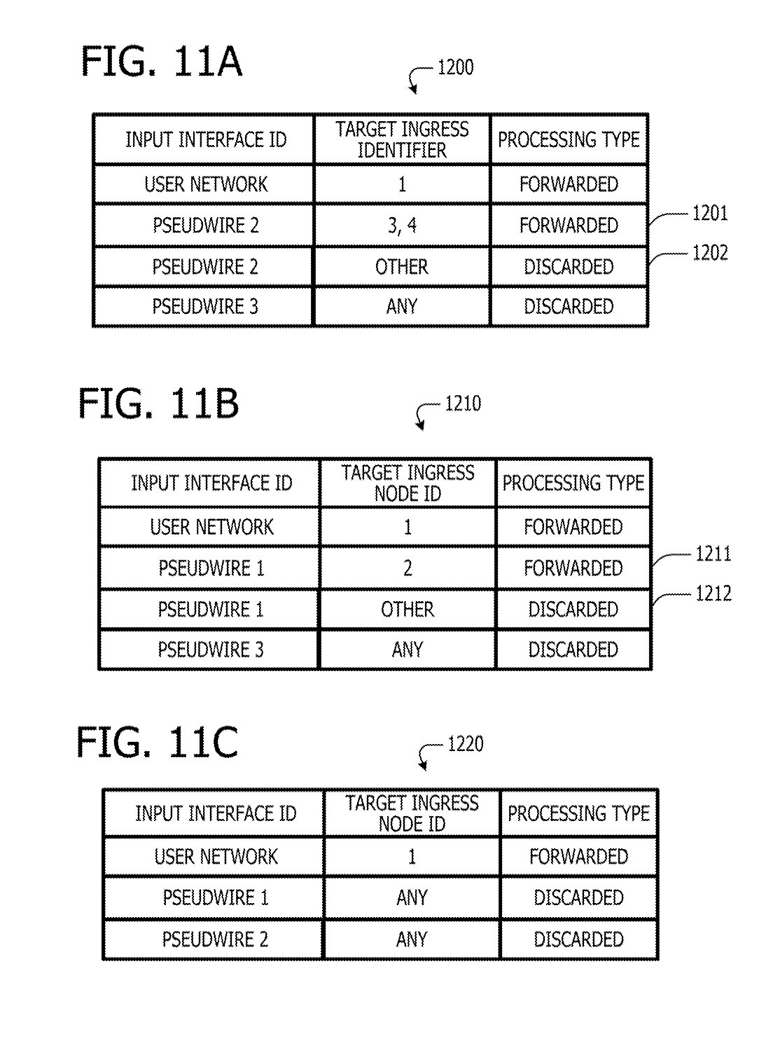

FIGS. 11A, 11B, 11C are diagrams illustrating examples of filter tables held by an edge router positioned along an alternative communication route, according to an embodiment. In FIGS. 11A, 11B, 11C, examples of filter tables held in the edge router 2-1 positioned along an alternative communication route 1103 are depicted. A filter table 1200 of FIG. 11A is a filter table corresponding to the pseudowire 3-1. A filter table 1210 of FIG. 11B is a filter table corresponding to the pseudowire 3-2. Further, a filter table 1220 of FIG. 11C is a filter table corresponding to the pseudowire 3-3.

In a manner similar to the filter table 400 depicted in FIG. 4, each cell of the leftmost columns (named “INPUT INTERFACE ID”) of filter tables 1200, 1210, 1220 contains an input interface ID identifying a pseudowire or a user network from which the MAC frame (a second packet) is received. Each cell of the middle column 402 (denoted by “TARGET INGRESS NODE ID”) contains a target ingress node ID that is used for determining whether the received packet (a second packet) is to be forwarded or discarded by comparing the ingress node ID contained in the received packet with the target ingress node ID. Each cell of the rightmost columns (denoted by “PROCESSING TYPE”) contains information identifying a processing method that is to be performed on the received packet (a second packet).

The row 1201 of the filter table 1200 indicates that a MAC frame (a second packet) that is received from the pseudowire 3-2 and having an ingress node ID “3” or “4” identifying the edge routers 2-3 or 2-4, respectively, should be forwarded to the pseudowire 3-1. The row 1202 indicates that a MAC frame (a second packet) that is received from the pseudowire 3-2 and having an ingress node ID identifying an edge router other than the edge router 2-3 or 2-4 should be discarded.

Similarly, the row 1211 of the filter table 1210 indicates that a MAC frame (a second packet) that is received from the pseudowire 3-1 and having an ingress node ID of “2” identifying the edge router 2-2 should be forwarded to the pseudowire 3-2. The row 1212 indicates that a MAC frame (a second packet) that is received from the pseudowire 3-1 and having an ingress node ID identifying an edge router other than the edge router 2-2 should be discarded.

The rows other than the above mentioned rows in the filter tables 1200 to 1220 indicate that only the MAC frame (a second packet) that is received from the user network 4-1 and having an ingress node ID “1” identifying the edge router 2-1 should be forwarded to the corresponding pseudowire.

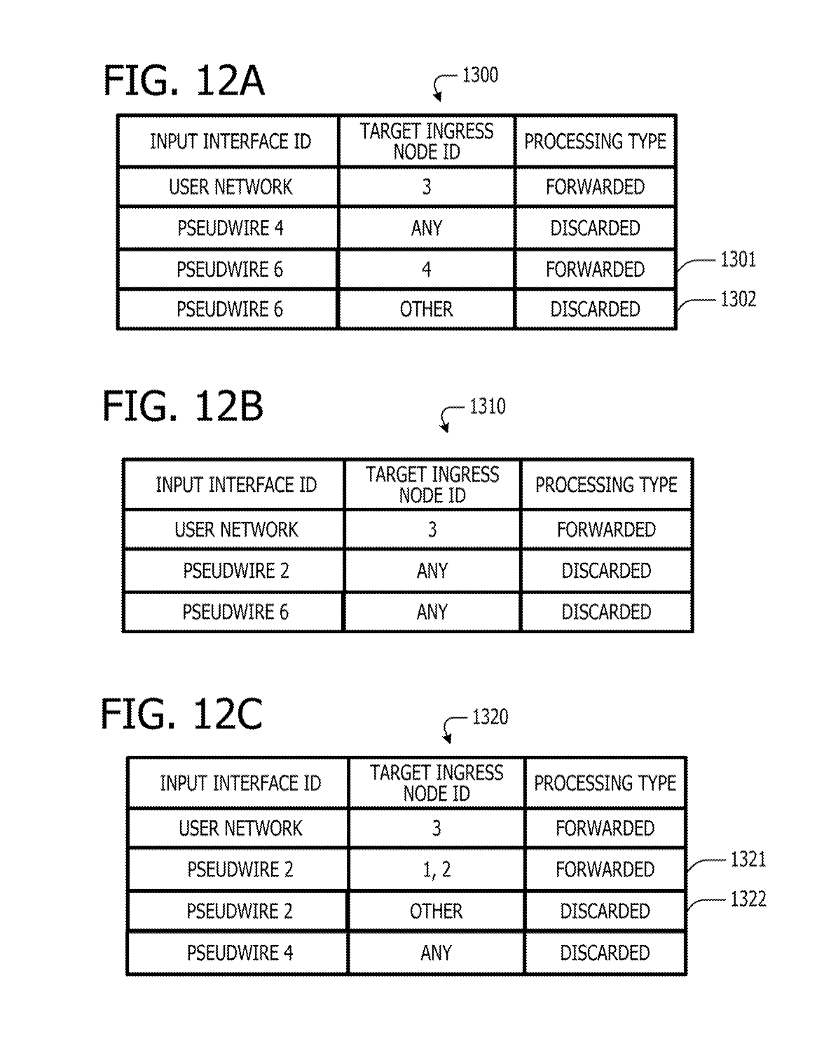

FIGS. 12A, 12B, and 12C are diagrams illustrating examples of filter tables held by an edge router positioned along an alternative communication route, according to an embodiment. In FIGS. 12A, 12B, 12C, examples of filter tables held in the edge router 2-3 positioned along an alternative communication route 1103 are depicted. A filter table 1300 of FIG. 12A is a filter table corresponding to the pseudowire 3-2. A filter table 1310 of FIG. 12B is a filter table corresponding to the pseudowire 3-4. Further, a filter table 1320 of FIG. 12C is a filter table corresponding to the pseudowire 3-6.

In a manner similar to the filter table 400 depicted in FIG. 4, each cell of the leftmost columns (named “INPUT INTERFACE ID”) of filter tables 1300, 1310, 1320 contain an input interface ID identifying a pseudowire or a user network from which the MAC frame (a second packet) is received. Each cell of the middle column 402 (denoted by “TARGET INGRESS NODE ID”) contains a target ingress node ID that is used for determining whether the received packet (a second packet) is to be forwarded or discarded by comparing the ingress node ID contained in the received packet with the target ingress node ID. Each cell of the rightmost columns (denoted by “PROCESSING TYPE”) contains information identifying a processing method that is to be performed on the received MAC frame.

The row 1301 of the filter table 1300 indicates that a MAC frame (a second packet) that is received from the pseudowire 3-6 and having an ingress node ID of “4” identifying the edge routers 2-4 should be forwarded to the pseudowire 3-2. The row 1302 indicates that a MAC frame (a second packet) that is received from the pseudowire 3-6 and having an ingress node ID identifying an edge router other than the edge router 2-4 should be discarded.

Similarly, the row 1321 of the filter table 1320 indicates that a MAC frame (a second packet) that is received from the pseudowire 3-2 and having an ingress node ID of “1” or “2” identifying the edge routers 2-1 or 2-2, respectively, should be forwarded to the pseudowire 3-6. The row 1322 indicates that a MAC frame (a second packet) that is received from the pseudowire 3-2 and having an ingress node ID identifying an edge router other than the edge routers 2-1 or 2-2 should be discarded.

The rows other than the above mentioned rows in the filter tables 1300 to 1320 indicate that only the MAC frame (a second packet) that is received from the user network 4-3 and having an ingress node ID of “3” identifying the edge router 2-3 (the own router) should be forwarded to the corresponding pseudowire.

In this way, the filter tables 1200 to 1220, 1300 to 1320 are defined so that a split horizon is cancelled with respect to a MAC frame (a second packet) received from the user networks coupled to the request and peer nodes of the faulty pseudowire 3-5. Therefore, the edge routers coupled by the faulty pseudowire are capable of communicating with each other via an alternative communication route that is set using existing pseudowires other than the faulty pseudowires even if a fault has been detected on a plurality of pseudowires in the communication system 1.

When the faulty pseudowire has recovered and the request and peer nodes of the faulty pseudowire have become able to exchange packets each other via the recovered pseudowire, the request node request other edge routers to release the alternative communication route, so as to be used by the other edge routers, by transmitting a split horizon setting message to the other edge routers. The split horizon setting message may be configured to include information similar to the route selection message depicted in FIG. 5. However, a hop count contained in the split horizon setting message may be set at the number of hops of the alternative communication route. Further, the split horizon setting message may be configured to include a flag indicating that the own message is a split horizon setting message.

Upon receiving a split horizon setting message, an edge router updates a filter table corresponding to each pseudowire, based on the received split horizon setting message. For example, the filter table is changed so as to discard a packet that is received from the pseudowire coupled to the route selection message transmitting node and having an ingress node ID identifying the request and peer nodes of the recovered pseudowire.

Further, the edge router modifies the split horizon setting message so that the route selection message transmitting node ID is set at the identification number of the own router and the hop count is decremented by “1”. Thereafter, the edge router that has received the split horizon setting message transmits the modified split horizon setting message to the other edge routers.

The edge router, coupled to the pseudowire that has recovered from the fault, deletes from the routing table held by the switch thereof, entries indicating transferring a packet through the pseudowire constituting the alternative communication route.

As described above, in a communication system according to an embodiment, when an edge router has detected a fault occurrence on a pseudowire that is operated under normal conditions, the edge router transmits a route selection message to the other edge routers. Upon receiving the route selection message, the other edge routers permits forwarding of a MAC frame that is received from a given pseudowire and having an ingress node ID identifying the edge routers coupled to the faulty pseudowire. This allows the communication system to establish an alternative communication route that bypasses the faulty pseudowire using the existing pseudowires other than the faulty pseudowires. Therefore, it is unnecessary for the communication system to prepare spare virtual communication paths beforehand. Accordingly, edge routers or core routers in the communication system are not needed to perform processing on the spare virtual communication paths which are prepared beforehand. Therefore, processing capacity required for each of edge routers and core routers may be lowered, and cost for each of edge routers and core routers in the communication system may be also reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A method for forwarding a packet among a plurality of edge nodes each coupled to a user network, each pair of edge nodes included in the plurality of edge nodes being coupled via a point-to-point link, the method comprising:
receiving, by a first edge node, a first packet from a first user network coupled to the first edge node, the first packet being destined for a second user network coupled to a second edge node;
creating, by the first edge node, a second packet by adding an ingress node identifier identifying the first edge node to the first packet;
forwarding, by the plurality of edge nodes, the second packet among the plurality of edge nodes using point-to-point links coupling the each pair of edge nodes included in the plurality of edge nodes, based on the ingress node identifier contained in the second packet and forwarding control information held in the each of the plurality of edge nodes, the forwarding control information including information indicating whether the second packet is to be forwarded or discarded in association with an ingress node identifier;
receiving, by the second edge node, the second packet from one of point-to-point links coupled to the second edge node;
restoring, by the second edge node, the second packet to the original first packet by deleting the ingress node identifier from the second packet, and transmitting the restored first packet to the second user network.

2. The method of claim 1, further comprising:
forwarding, by the first and second edge nodes, the second packet between the first and second edge nodes via a first point-to-point link coupling the first and second edge nodes, under normal conditions;
at the time of detecting a fault occurrence on the first point-to-point link, determining, by the first and second edge nodes, one of the first and second edge nodes to be a request node of the first point-to-point link that controls selection and setting of an alternate communication route for the first point-to-point link, and determining the other one of the first and second edge nodes to be a peer node of the first point-to-point link;
searching, by the request node of the first point-to-point link, one or more edge nodes other than the request and peer nodes, for an alternative sequence of edge nodes in which adjacent edge nodes are capable of communicating with each other via one point-to-point link, and foremost and rearmost edge nodes of the alternative sequence of edge nodes are capable of communicating with the request and peer nodes via one point-to-point link, respectively;
determining, by the request node, a route that includes the request node, the alternative sequence of edge nodes, and the peer node, to be the alternative communication route for the first point-to-point link; and
setting, by the alternative sequence of edge nodes, the forwarding control information held by each of the alternative sequence of edge nodes so that the second packet is forwarded along the alternative communication route between the request node and the peer node of the first point-to-point link.

3. The method of claim 2, further comprising:
transmitting, by the request node, a route selection message to each of the one or more edge nodes other than the request and peer nodes, the route selection message including request and peer node identifiers that identify the request and peer nodes of the first point-to-point link, respectively;
transferring, by the one or more edge nodes, the route selection message among the one or more edge nodes until the route selection message is transferred to a third edge node capable of communicating with the peer node via one point-to-point link; and
determining, by the request node, a sequence of edge nodes to which the route selection message has been transferred, to be the alternative sequence of edge nodes.

4. The method of claim 3, wherein
the route selection message further includes a hop count indicating the maximum number of edge nodes included in the alternative sequence of edge nodes to be searched for; and
the route selection message is transferred among the one or more edge nodes, until the route selection message is transferred to the third edge node capable of communicating with the peer node via one point-to-point link, or until the number of a sequence of edge nodes to which the route selection message has been transferred, reaches the value of the hop count.

5. The method of claim 4, wherein
the request node set a value 1 to the hop counter of the route selection message; and
the request node repeats a transmission of the route selection message to the one or more edge nodes while incrementing the value of the hop count by 1 each time the transmission has completed, until the route selection message is transferred to the third edge node capable of communicating with the peer node via one point-to-point link, so as to find the alternative communication route including the smallest number of edge nodes.

6. The method of claim 2, wherein
an edge node in the plurality of edge nodes includes, as forwarding control information thereof, a frame filter table corresponding to each of point-to-point links to which the second packet is to be forwarded, the frame filter table storing one or more forwarding control records each associated with one of input interfaces, the input interfaces each corresponding to one of point-to-point links from which the second packet is received or a user network from which the first packet is received, the one or more forwarding control records each including:
an input interface identifier identifying one of point-to-point links from which the second packet is received or the user network from which the first packet is received;
a target ingress node identifier identifying a target ingress node; and
a processing type indicating whether the second packet that has been received via the input interface identified by the input interface identifier and contains an ingress node identifier corresponding to the target ingress node identifier, is to be forwarded to a point-to-point link corresponding to the frame filter or discarded, wherein
at the time of a fault occurrence on the first point-to-point link, each of the alternative sequence of edge nodes sets frame tables thereof so that the second packet having an ingress node identifier identifying the request or peer nodes of the first point-to-point link, is forwarded along the alternative communication route, and the second packet having an ingress node identifier identifying an edge node other than the request or peer nodes of the first point-to-point link is discarded.

7. A method for forwarding a packet, by an edge node, among a plurality of edge nodes each coupled to a user network, each pair of edge nodes included in the plurality of edge nodes being coupled via a point-to-point link, the edge node being coupled to a plurality of point-to-point links, the method comprising:
providing the edge node with forwarding control information for controlling packet forwarding;
receiving, by the edge node, a first packet from the user network coupled to the edge node;
creating, by the edge node, a second packet by adding an ingress node identifier identifying the edge node to the first packet;
forwarding, by the edge node, based on the forwarding control information, the created second packet to one of the plurality of point-to-point links serving as a destination of the created second packet;
receiving, by the edge node, as the second packet, another second packet created by another edge node in the plurality of edge nodes, from one of the plurality of point-to-point links;
forwarding, by the edge node, based on the forwarding control information, the another second packet to one of the plurality of point-to-point links serving as a destination of the another second packet when the another second packet is not destined for the user network coupled the edge node; and
deleting, by the edge node, the ingress node identifier contained in the another second packet when the another second packet is destined for the user network coupled the edge node, so as to transmit the another second packet in which the ingress node identifier is deleted to the user network coupled to the edge node.

8. The method of claim 7, further comprising:
detecting, by the edge node, a fault occurrence on a first point-to-point link coupling the edge node and a peer edge node in the plurality of edge nodes;
searching, by the edge node, one or more edge nodes other than the edge node and the peer edge node, for an alternative sequence of edge nodes in which adjacent edge nodes are capable of communicating with each other via a point-to-point link, foremost and rearmost edge nodes of the alternative sequence of edge nodes being capable of communicating with the edge node and the peer edge node via one point-to-point link, respectively;
selecting, by the edge node, a route including the edge node, the alternative sequence of edge nodes, and the peer edge node, as the alternative communication route for the first point-to-point link; and
controlling, by the edge node, the setting of the forwarding control information held by each of the alternative sequence of edge nodes so that the second packet is forwarded along the alternative communication route between the edge node and the peer edge node.

9. The method of claim 8, wherein
a route selection message is transmitted from the edge node to each of the one or more edge nodes, the route selection message including identifiers identifying the edge node and the peer edge node;
the route selection message is transferred among the one or more edge nodes until the route selection message is transferred to a third edge node capable of communicating with the peer edge node via one point-to-point link; and
a sequence of edge nodes to which the route selection message has been transferred, is determined to be the alternative sequence of edge nodes.

10. The method of claim 9, wherein
the route selection message further includes a hop count indicating the maximum number of edge nodes included in the alternative sequence of edge nodes to be searched for; and
the route selection message is transferred among the one or more edge nodes, until the route selection message is transferred to the third edge node capable of communicating with the peer edge node via one point-to-point link, or until the number of a sequence of edge nodes to which the route selection message has been transferred, reaches the value of the hop count.

11. The method of claim 10, wherein
the edge node set a value 1 to the hop count of the route selection message; and
the edge node repeats a transmission of the route selection message to the one or more edge nodes while incrementing the value of the hop count by 1 each time the transmission has completed, until the route selection message is transferred to the third edge node capable of communicating with the peer edge node via one point-to-point link, so as to find the alternative communication route including the smallest number of edge nodes.

12. The method of claim 7, wherein
the forwarding control information includes a frame filter table provided for each of the plurality of point-to-point links serving as a forwarding destination of the second packet, the frame filter table storing one or more forwarding control records each associated with one of input interfaces, the input interfaces each corresponding to one of point-to-point links from which the another second packet is received or a user network from which the first packet is received, the one or more forwarding control records each including:
an input interface identifier identifying one of the plurality of point-to-point links from which the another second packet is received or the user network from which the first packet is received;
a target ingress node identifier identifying a target ingress node; and
a processing type indicating whether the second packet is to be forwarded to a point-to-point link corresponding to the frame filter table or discarded wherein the second packet has been received via the input interface identified by the input interface identifier and contains an ingress node identifier corresponding to the target ingress node identifier.

13. The method of claim 8, further comprising:
detecting, by the edge node, the fault occurrence on the first point-to-point link;
receiving, by the edge node, the first packet destined for a peer user network coupled to the peer edge node via the user network coupled to the edge node; and
flooding, by the edge node, the second packet created from the first packet destined for the peer user network, toward all the plurality of point-to-point links.
